(19) United States
(12) Patent Application Publication
(10) Pub. No.: US 2023/0302766 A1
(43) Pub. Date: Sep. 28, 2023

(54) SEMI-FINISHED PRODUCT

(71) Applicant: SGL CARBON SE, Wiesbaden (DE)

(72) Inventors: Fabian SCHUBERT, Meitingen (DE); Tanja DAMJANOVIC, Meitingen (DE)

(73) Assignee: SGL CARBON SE, Wiesbaden (DE)

(21) Appl. No.: 18/040,044

(22) PCT Filed: Aug. 2, 2021
(86) PCT No.: PCT/EP2021/071554

§ 371 Date: Jan. 31, 2023

(30) Foreign Application Priority Data
Jul. 31, 2020 (DE) 10 2020 209 713.5

(51) Int. Cl. B32B 5/26; B32B 5/12; B32B 5/02

(52) U.S. Cl. CPC B32B 5/266; B32B 5/12; B32B 5/022; B32B 2262/106; B32B 2260/023; B32B 2260/046; B32B 2250/20; B32B 2264/108; B32B 2307/3065; B32B 2607/00

(57) ABSTRACT

A semi-finished product, to a laid scrim including the semi-finished product, to a component including the laid scrim, and to their production and use for producing a fire protection panel.

### FIELD

The present invention relates to a semi-finished product, to a laid scrim comprising the semi-finished product, to a component comprising the laid scrim, and to their production and use for producing a fire protection panel.

In the context of the invention, a fire protection panel is understood to be a cladding element which is formed as a sheet or curved sheet and can have a load-bearing function.

### BACKGROUND

Intumescent materials have been used in fire protection applications up to now. For this purpose, graphite salts, i.e. exfoliated graphites, are often used, which are embedded in composite resin or incorporated in mineral fibre knitted fabrics. This is described, for example, in WO2018/094002A1.

In the aforementioned fire protection systems in which graphite salts are used, these are not integrated in a carrier material. The use of the pure fire protection material is therefore not suitable for applications which are exposed to a specific mechanical load. Consequently, an additional carrier material must always be used for a load-bearing component design.

This presents further challenges, such as the stability of a bond between the carrier material and the fire protection material and the fire protection system which is thicker as a result of this combination, which fire protection system is less flexible in terms of design.

### SUMMARY

The object of the present invention is therefore to provide a semi-finished product, a laid scrim, a component, and their production and use for producing a fire protection panel which overcomes the disadvantages of the prior art described above.

The object is achieved by providing a semi-finished product comprising fibres, matrix and graphite salt.

Graphite salt is a precursor obtained in the production of expanded graphite. For this purpose, graphite, such as natural graphite, is usually mixed with intercalates, such as nitric acid or sulphuric acid. In order to obtain expanded graphite from the graphite salt, said salt is heat treated at an elevated temperature of, for example, 600° C. to 1200° C. (DE10003927A1).

According to the invention, the semi-finished product has a layer comprising fibres and matrix. In the context of the invention, “layer” is understood to be the smallest unit of fibres and matrix.

Advantageously, the graphite salt is applied to at least one side of the layer.

The advantage of the semi-finished product is that the graphite salt is already integrated, so that bonding the component made from the fibre composite-based semi-finished product to a separate fire protection layer can be avoided as the component can bear loads and at the same time has fire protection properties.

According to the invention, the amount of graphite salt is 5-50 g/m²; preferably 15-35 g/m². With less than 5 g/m², the protective effect of the semi-finished product is too low when used as a fire protection panel and with more than 50 g/m² the amount of graphite salt is too high, so that lamination of the individual layers of semi-finished products is no longer possible or only insufficiently possible. In addition, at more than 50 g/m², the mechanical properties of the component resulting from the semi-finished product become significantly worse, as the bond between the individual layers of the semi-finished products becomes poor due to too much graphite salt. By integrating the graphite salt into the semi-finished product, it can be further processed directly and a time-consuming intermediate step for adding the graphite salt is no longer necessary. In the event of a fire, the graphite salt expands, as is known from the production of expanded graphite, thereby providing an insulation barrier against the source of the fire. In addition, the expansion can seal joints, corners and leaks and thus, on the one hand, reduce the oxygen supply to the fire and, on the other hand, prevent smoke from passing through the fire protection panel. In the range of 15-35 g/², the ratio of good mechanical properties in the non-fire case and the existing fire protection effect in the fire case is particularly advantageous.

Advantageously, the fibres are selected from the group consisting of carbon fibres, glass fibres, aramid fibres, metal fibres, ceramic fibres, natural fibres and basalt fibres or mixtures thereof, preferably carbon fibres.

Carbon fibres have the effect of achieving very good mechanical properties and only low thermal expansion in the event of fire and are therefore particularly advantageous for large-area applications.

According to the invention, the fibres are in the form of continuous fibres, rovings, woven or nonwoven fabric. A nonwoven fabric is understood to be a structure comprising long or continuous fibres.

Advantageously, the matrix is selected from the group consisting of duromers, preferably phenolic resins, benzoxazine resins, epoxy resins, particularly preferably epoxy resins or phenolic resins.

A further subject of the invention is a laid scrim comprising at least two stacked layers of the semi-finished product. The layers can be stacked in any orientation of the fibres of the individual layers, i.e. any orientation from 0°-90° can be selected.

According to the invention, in the laid scrim, the sides of the semi-finished product having graphite salt of the at least two stacked layers of the semi-finished product lie towards each other or on the opposite sides of the layers of the semi-finished product.

A further subject of the invention is a component comprising the laid scrim, wherein the laid scrim is cured. “Cured” means that the matrix changes to a solid state with chemical cross-linking, but the graphite salt remains in the form of graphite salt.

A further subject of the invention is a method of producing a semi-finished product comprising the following steps:
a) providing a layer made of fibres and a matrix;
b) providing graphite salt;
c) applying 5-50 g/² of graphite salt to the layer prepared in step a), preferably 15-35 g/²;
d) applying a pressure, by means of a calender, of 0.5-10 bar, preferably 2-6 bar and treating with a temperature of 20-120° C., preferably 20-100° C., particularly preferably 20-80° C.

A further subject of the invention is the use of the semi-finished product for the production of a fire protection panel.

A further subject of the invention is the use of the laid scrim for the production of a fire protection panel.

A further subject of the invention is the use of the component for the production of a fire protection panel.

### BRIEF DESCRIPTION OF THE FIGURES

In the following, purely by way of example, the present invention is described by way of advantageous embodiments and with reference to the accompanying drawings.

FIG. 1: is a perspective view of a semi-finished product (5);

FIG. 2: is a perspective view of a laid scrim (6);

FIG. 3: is a perspective view of a laid scrim (6);

FIG. 4: is a perspective view of a laid scrim (6);

### DETAILED DESCRIPTION

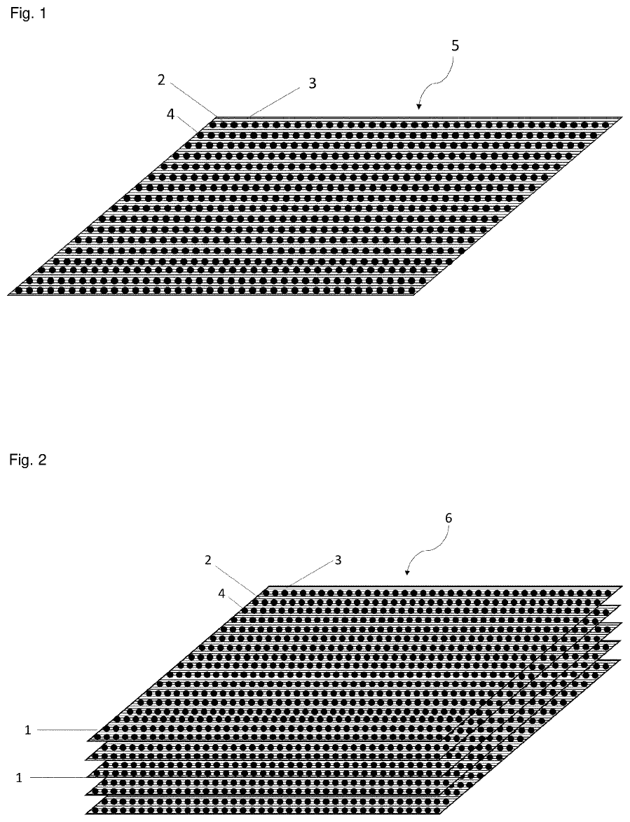

FIG. 1 is a perspective view of a semi-finished product (5), wherein graphite salt (4) is applied to the layer (1) made of fibres (2) and a matrix (3).

FIG. 2 is a perspective view of a laid scrim (6) consisting of six layers (1) made of fibres (2) and a matrix (3), with graphite salt (4) being applied to each layer (1).

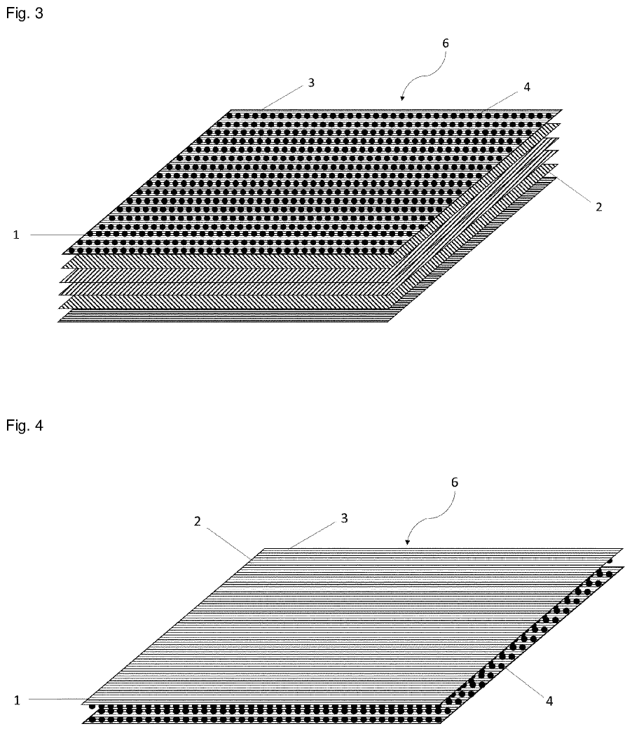

FIG. 3 is a perspective view of a laid scrim (6) consisting of six layers (1) made of fibres (2) and a matrix (3), with graphite salt (4) applied only to the uppermost layer (1).

FIG. 4 is a perspective view of a laid scrim (6) consisting of two layers (1) made of fibres (2) and a matrix (3), with the graphite salt (4) of the two layers lying on top of one another.

The present invention is explained below using embodiments which, however, do not represent any limitation of the invention.

The production of a semi-finished product can be carried out as described below.

### Embodiment 1

To produce the semi-finished product (5), a film of an epoxy resin is raked as a matrix (3) having a weight per unit area of 100 g/m², sprinkled with 30 g/m² graphite salt (4) and then laminated with unidirectional carbon fibres (2), where “unidirectional” means that all fibres are oriented in a single direction. The applied carbon fibres are arranged in such a way that they have a weight per unit area of 150 g/m². By means of rollers/calender and heating zone, a mechanical pressure of 2 bar and a temperature effect of 70° C. are applied to the material, resulting in a bond of carbon fibres (2), epoxy resin (3) and graphite salt (4). This pre-impregnated semi-finished product is provided with release paper and wound onto a roll and serves as the starting material for the subsequent production of the cladding element.

### Embodiment 2

To produce the laid scrim (6), eight layers of the semi-finished product (5) from embodiment 1 are cut to size and laid one on top of the other as a quasi-isotropic structure (0°, 45°, 90°, −45°, −45°, 90°, 45°, 0°), whereby “quasi-isotropic” means that in all directions within the plane approximately the same mechanical properties are produced for the laid scrim (6), i.e. the totality of all layers of fibres (2) and matrix (3).

### Embodiment 3

The laid scrim (6) from embodiment 2 is then cured for 60 min at 120° C. and a pressure of 6 bar in a hot pressing process, thereby transforming it into a final component. In this process, the epoxy resin is cross-linked to form a complete plastics material structure without the graphite salt (4) beginning to expand, thus preventing its potential insulating and thus fire-protective effect from developing prematurely.

### LIST OF REFERENCE SIGNS

(1) Layer
(2) Fibre
(3) Matrix
(4) Graphite salt
(5) Semi-finished product
(6) Laid scrim
(7) Component

1-14. (canceled)

15. A semi-finished product comprising fibres, a matrix and graphite salt.

16. The semi-finished product according to claim 15, wherein the semi-finished product has a layer comprising fibres and a matrix.

17. The semi-finished product according to claim 15, wherein the graphite salt is applied to at least one side of the layer.

18. The semi-finished product according to claim 15, wherein the amount of graphite salt is 5-50 g/m².

19. The semi-finished product according to claim 15, wherein the fibres are selected from the group consisting of carbon fibres, glass fibres, aramid fibres, metal fibres, ceramic fibres, natural fibres and basalt fibres or mixtures thereof.

20. The semi-finished product according to either claim 15, wherein the fibres are in the form of continuous fibres, rovings, woven or nonwoven fabric.

21. The semi-finished product according to claim 15, wherein the matrix is selected from the group consisting of duromers.

22. A laid scrim comprising at least two stacked layers of the semi-finished product according to claim 15.

23. The laid scrim according to claim 22, wherein the respective layer of graphite salt of the at least two stacked layers of the semi-finished product lie on top of one another or on opposite sides of the layers of the semi-finished product.

24. A component comprising the laid scrim according to claim 22, wherein the laid scrim is cured.

25. A method for producing a semi-finished product according to claim 15 comprising the following steps:
a) providing a layer made of fibres and a matrix;
b) providing graphite salt;
c) applying 5-50 g/m² of graphite salt to the layer prepared in step a);
d) applying a pressure by a calender of 0.5-10 bar, preferably 2-6 bar and treating at a temperature of 20-120° C., preferably 20-100° C., particularly preferably 20-80° C.
